(19) United States
(12) Patent Application Publication
(10) Pub. No.: US 2017/0115534 A1
(43) Pub. Date: Apr. 27, 2017

(54) ARRAY SUBSTRATE, MANUFACTURING METHOD THEREOF AND DISPLAY DEVICE

(71) Applicants: BOE TECHNOLOGY GROUP CO., LTD., Beijing (CN); CHONGQING BOE OPTOELECTRONICS TECHNOLOGY CO., LTD., Chongqing (CN)

(72) Inventors: Peng LI, Beijing (CN); Zhenghao PIAO, Beijing (CN); Hee Cheol KIM, Beijing (CN)

(21) Appl. No.: 15/253,003

(22) Filed: Aug. 31, 2016

(30) Foreign Application Priority Data
Oct. 22, 2015 (CN) 201510690739.4

(51) Int. Cl. G02F 1/1343

(52) U.S. Cl. CPC G02F 1/134309; G02F 1/13439; G02F 2001/134318; G02F 2201/121; G02F 2201/123

(57) ABSTRACT

An array substrate, a manufacturing method thereof and a display device are provided. The array substrate includes a pattern of pixel electrodes and a pattern of common electrodes. The pattern of pixel electrodes includes a plurality of strip-like pixel electrodes. The pattern of common electrodes includes a plurality of strip-like common electrodes. Projection of one of every two adjacent pixel electrodes on the substrate is located between projections of two adjacent common electrodes on the substrate, and projection of the other pixel electrode of the every two adjacent pixel electrodes on the substrate is located within projection of one of the two adjacent common electrodes on the substrate.

### TECHNICAL FIELD

Embodiments of the present disclosure relate to an array substrate and a manufacturing method thereof, as well as a display device.

### BACKGROUND

In liquid crystal display technology, AD-SDS (ADvanced Super Dimension Switch, ADS) mode is gradually replacing TN (Twisted Nematic) liquid crystal mode to be one of important technologies in liquid crystal display field due to its advantages of high transmittance, wide viewing angle, fast response speed and low power consumption.

In an ADS mode display device, a multi-dimensional electric field is formed with a parallel electric field produced at edges of slit electrodes in a same plane and a vertical electric field produced between a slit electrode layer and a plate electrode layer, so that liquid crystal molecules at all orientations, which are located directly above the electrodes and between the slit electrodes in a liquid crystal cell, can be rotated, which enhances the work efficiency of the liquid crystals and increases light transmittance. The AD-SDS technology can improve the image quality of display devices and has advantages of high transmittance, low power consumption, wide viewing angles, high aperture ratio, low chromatic aberration, no push Mura, or the like.

### SUMMARY

At least one embodiment of the present disclosure provides an array substrate, including: a substrate and a pattern of pixel electrodes and a pattern of common electrodes formed over the substrate. The pattern of pixel electrodes and the pattern of common electrodes are located in different layers. The pattern of pixel electrodes includes a plurality of strip-like pixel electrodes. The pattern of common electrodes includes a plurality of strip-like common electrodes. Projection of one of every two adjacent pixel electrodes on the substrate is located between projections of two adjacent common electrodes on the substrate, and projection of the other pixel electrode of the every two adjacent pixel electrodes on the substrate is located within projection of one of the two adjacent common electrodes on the substrate.

In an example, each of the plurality of strip-like pixel electrodes in the pattern of pixel electrodes has a width equal to each other, and any two adjacent pixel electrodes have a distance equal to each other.

In an example, each of the plurality of strip-like common electrodes in the pattern of common electrodes has a width equal to each other, and any two adjacent common electrodes have a distance equal to each other.

In an example, a sum of the width of each common electrode and the distance between any two adjacent common electrodes is twice of a sum of the width of each pixel electrode and the distance between any two adjacent pixel electrodes.

In an example, the projection of the other pixel electrode on the substrate has a central line coincided with that of the projection of a corresponding common electrode on the substrate.

In an example, the width of the common electrodes equals to the distance of any two adjacent common electrodes.

In an example, the width of each pixel electrode is 2.6±0.1 μm, and the distance between any two adjacent pixel electrodes is 5.4±0.1 μm.

In an example, the width of each common electrode is 8-10 μm.

At least one embodiment of the present disclosure provides a method of manufacturing an array substrate, including: forming a pattern of pixel electrodes and a pattern of common electrodes over a substrate. The pattern of pixel electrodes and the pattern of common electrodes are formed in different layers. The pattern of pixel electrodes includes a plurality of strip-like pixel electrodes and the pattern of common electrodes includes a plurality of strip-like common electrodes. Projection of one of every two adjacent pixel electrodes on the substrate is located between projections of two adjacent common electrodes on the substrate, and projection of the other pixel electrode of the every two adjacent pixel electrodes on the substrate is located within projection of one of the two adjacent common electrodes on the substrate.

In an example, each of the plurality of strip-like pixel electrodes in the pattern of pixel electrodes has a width equal to each other, and any two adjacent pixel electrodes have a distance equal to each other.

In an example, each of the plurality of strip-like common electrodes in the pattern of common electrodes has a width equal to each other, and any two adjacent common electrodes have a distance equal to each other.

In an example, a sum of the width of each common electrode and the distance between any two adjacent common electrodes is twice of a sum of the width of each pixel electrode and the distance between any two adjacent pixel electrodes.

In an example, the projection of the other pixel electrode on the substrate has a central line coincided with that of the projection of a corresponding common electrode on the substrate.

In an example, the width of each pixel electrode is 2.6±0.1 μm, and the distance between any two adjacent pixel electrodes is 5.4±0.1 μm.

Embodiments of the present disclosure also provide a display device, including the array substrate.

### BRIEF DESCRIPTION OF THE DRAWINGS

Embodiments of the present disclosure will be described in more detail as below in conjunction with the accompanying drawings to enable those skilled in the art to understand the present disclosure more clearly, in which,

FIG. 1 is a schematic structural diagram of an array substrate;

FIG. 2 is a schematic structural diagram of an array substrate provided in an embodiment of the present disclosure;

FIG. 3 is a schematic structural diagram of another array substrate provided in an embodiment of the present disclosure;

FIG. 4 is a comparison diagram of the capacitance value of the storage capacitor of the array substrate in FIG. 2 vs. the capacitance value of the storage capacitor of the array substrate in FIG. 1;

FIG. 5 is a comparison diagram of the V-T curve of the array substrate in FIG. 2 vs. the V-T curve of the array substrate in FIG. 1;

FIG. 6 is a comparison diagram of the capacitance value of the storage capacitor of the array substrate in FIG. 3 vs. the capacitance value of the storage capacitor of array substrate in FIG. 1; and

FIG. 7 is a comparison diagram of the V-T curve of the array substrate in FIG. 3 vs. the V-T curve of the array substrate in FIG. 1.

### DETAILED DESCRIPTION

Technical solutions according to the embodiments of the present disclosure will be described clearly and understandable as below in conjunction with the accompanying drawings of embodiments of the present disclosure. It is apparent that the described embodiments are only a part of but not all of exemplary embodiments of the present disclosure. Based on the described embodiments of the present disclosure, various other embodiments can be obtained by those of ordinary skill in the art without creative labor and those embodiments shall fall into the protection scope of the present disclosure.

Unless otherwise defined, all the technical and scientific terms used herein have the same meanings as commonly understood by one of ordinary skill in the art to which the present disclosure belongs. The terms, such as “first,” “second,” or the like, which are used in the description and the claims of the present application, are not intended to indicate any sequence, amount or importance, but for distinguishing various components. Also, the terms, such as “comprise/comprising,” “include/including,” or the like are intended to specify that the elements or the objects stated before these terms encompass the elements or the objects and equivalents thereof listed after these terms, but not preclude other elements or objects. The terms, “on,” “under,” or the like are only used to indicate relative position relationship, and when the position of the object which is described is changed, the relative position relationship may be changed accordingly.

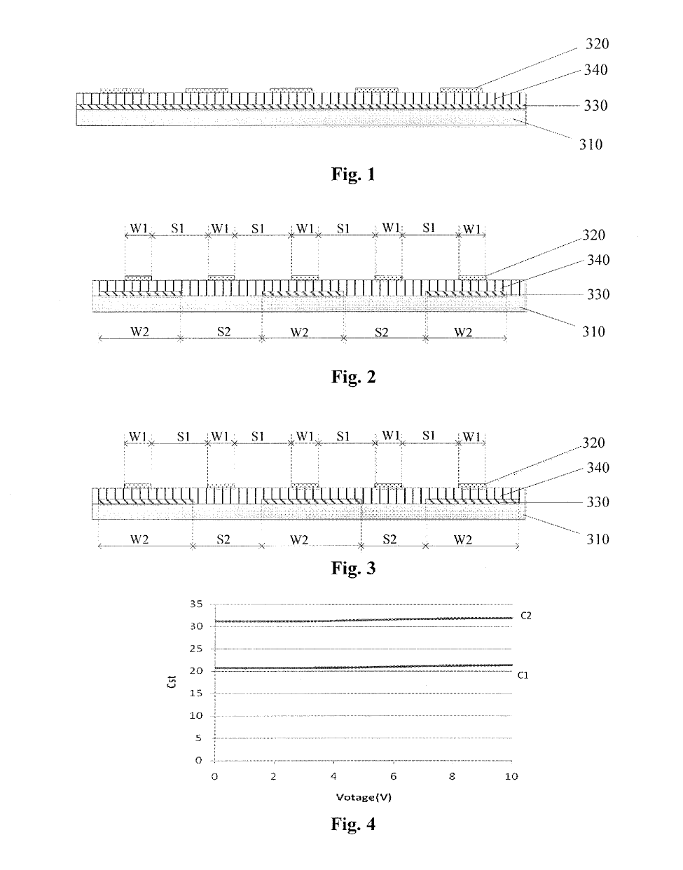

A configuration of the array substrate in an ADS mode display panel may be as shown in FIG. 1, which includes a substrate 310, pixel electrodes 320 formed on the substrate 310, common electrodes 330 and an insulating layer 340 between the pixel electrodes 320 and the common electrodes 330. The inventors found out that in the array substrate of FIG. 1, the pixel electrodes and common electrodes overlap with each other with a large area, which may result in large overlap capacitance and difficult charging of pixel electrodes.

An embodiment of the present disclosure provides an array substrate including: a substrate and a pattern of pixel electrodes and a pattern of common electrodes formed over the substrate. The pattern of pixel electrodes and the pattern of common electrodes are in different layers. The pattern of pixel electrodes includes a plurality of strip-like pixel electrodes. The pattern of common electrodes includes a plurality of strip-like common electrodes. Projection of one of every two adjacent pixel electrodes on the substrate is located between projections of any two adjacent common electrodes on the substrate, and projection of the other pixel electrode of the every two adjacent pixel electrodes on the substrate is located within projection of one of the two adjacent common electrodes on the substrate.

In the array substrate provided in the embodiment of the present disclosure, in every two pixel electrodes, one pixel electrode has its projection located between projections of two adjacent common electrodes. In this way, half pixel electrodes and common electrodes would not have any overlapping area. It is possible to reduce the area of overlapping area between pixel electrode and common electrodes, and reduce corresponding overlapping capacitance and charging difficulty.

The above-mentioned structure of array substrate may take a plurality of different forms which will be described in detail below with reference to accompanying drawings.

Referring to FIGS. 2 and 3, the array substrate provided in an embodiment of the present disclosure includes a substrate 310, a plurality of pixel electrodes 320 formed on the substrate 310, a plurality of common electrodes 330 and an insulating layer 340 between the pixel electrodes 320 and the common electrodes 330. Plural pixel electrodes 320 are included in a pattern of pixel electrodes, plural common electrodes 330 are included in a pattern of common electrodes, and the pattern of pixel electrodes and the pattern of common electrodes are formed in different layers with an insulating layer 340 isolating them from each other. The pixel electrodes 320 are arranged with an equal distance (with the distance between any two adjacent pixel electrodes 320 denoted as S1) and the pixel electrodes have an equal width (with the width of pixel electrodes denoted as W1). The common electrodes 330 are also arranged with an equal distance (with the width of the distance between any two adjacent common electrodes 330 denoted as S2) and the common electrodes 330 also have an equal width (with the width of common electrodes 330 denoted as W2).

Referring to FIGS. 2 and 3, in any two adjacent pixel electrodes 320, one pixel electrode 320 is located above the region between two adjacent common electrodes 330, that is, projection of the pixel electrode 320 on the substrate 310 is located between projections of two adjacent common electrodes 330 on the substrate 310; while the other pixel electrode 320 is located right above a common electrode 330, that is, projection of this pixel electrode 320 on the substrate 310 is within projection area of corresponding common electrode 330 on the substrate 310.

The array substrate as shown in FIGS. 2 and 3, in every two adjacent pixel electrodes 320, one pixel electrode 320 is not located right above a common electrode 330, that is, there is no overlapping area between the pixel electrode 320 and the common electrode 330, it is possible to significantly reduce corresponding overlapping capacitance and reduce the difficulty of charging pixel electrodes 320 as compared with the solution in FIG. 1.

For example, a sum of the width W2 of a common electrode 330 and the distance S2 between any two adjacent common electrodes 330 may be twice of a sum of the width W1 of a pixel electrode 320 and the distance S1 between any two adjacent pixel electrodes 320. In this way, regardless of the relative position relationship between common electrodes 330 and pixel electrodes 320, it is possible to readily realize a design in which projection of one of every two adjacent pixel electrodes 320 on the substrate 310 is located between projections of any two adjacent common electrodes 330 on the substrate 310, and projection of the other pixel electrode of the every two adjacent pixel electrodes 320 on the substrate 310 is located within projection of one of the two adjacent common electrode 330 on the substrate 310, so that the design difficulty is reduced.

Referring to FIGS. 2 and 3, for example, the pixel electrode 320 above the common electrode 330 may correspond to the middle region of the underlying common electrode 330. For example, the central line of the projection of the pixel electrode 320 on the substrate 310 may coincide with the central line of the projection of the common electrode 330 at corresponding location on the substrate 310. But embodiments of the present disclosure are not limited thereto, other designs may also utilized.

For example, the width W1 of the mentioned each pixel electrode may be 2.6±0.1 μm, and the distance S1 between two adjacent pixel electrodes may be 5.4±0.1 μm. This design can significantly reduce the value of overlapping capacitance.

Referring again to FIGS. 2 and 3, for example, the width W2 of a common electrode 330 and the distance S2 between two adjacent common electrodes 330 may be substantially identical with each other. In this way, it is possible to make the transmittance (T) of corresponding display device under different voltages (V) substantially identical to the transmittance of the display device in FIG. 1 under different voltages. That is, in this way, the area of common electrodes can be reduced.

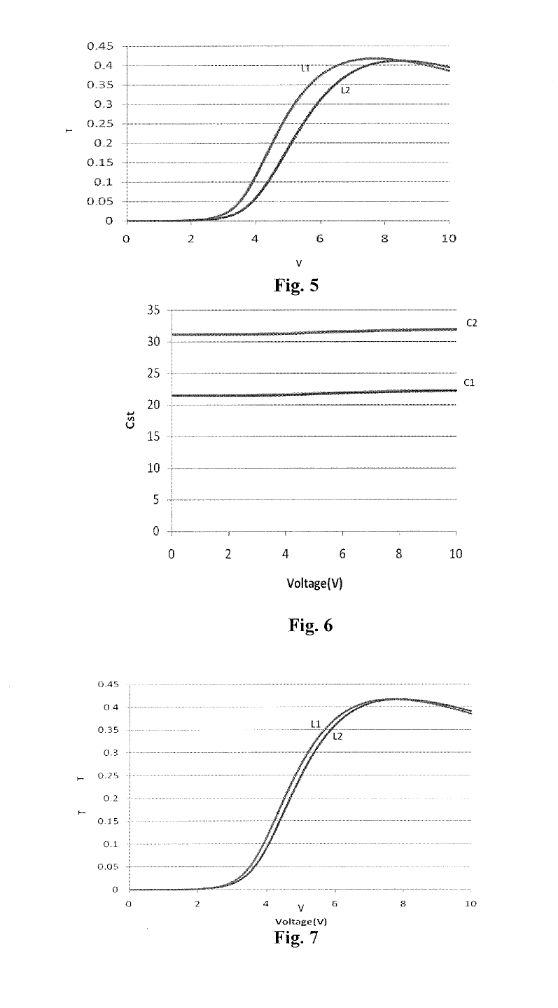

For example, as shown in FIG. 2, for example, the width W2 of common electrodes 330 herein and the distance S2 between two adjacent common electrodes 330 may be all identical. For example, given a width W1 of the pixel electrode of 2.6 μm and a distance S1 between two adjacent pixel electrodes of 5.4 μm, the width W2 of common electrodes 330 herein and the distance S2 between two adjacent common electrodes 330 may both be 8 μm. FIG. 4 is a diagram of capacitance values Cst obtained by simulating the array substrate in FIG. 2 and the array substrate in FIG. 1 under different driving voltages Voltage (V) in this case. The capacitance value C2 of the array substrate in FIG. 2 under the voltages is reduced about 33.2% lower than the capacitance value C1 of the array substrate in FIG. 1 under the voltages. FIG. 5 is a schematic diagram of a driving voltage V-transmittance Transmitance (T) curve L2 obtained by testing a display device including the array substrate of FIG. 2 under different driving voltages and a driving V-T curve L1 obtained by testing a display device including the array substrate of FIG. 1 under different driving voltages in such a case. As shown in FIG. 5, the V-T curve L2 of the display device including the array substrate of FIG. 2 substantially coincides with the V-T curve L1 of the display device including the array substrate of FIG. 1.

For example, it is also possible as shown in FIG. 3 that the width W2 of the common electrodes 330 may also be slightly larger than the distance between two adjacent common electrodes 330. For example, given a width W1 of the pixel electrode of 2.6 μm and a distance S1 between pixel electrodes of 5.4 μm, the width W2 of common electrodes 330 herein may be 10 μm while the distance S2 between two adjacent common electrodes 330 may be 6 μm. FIG. 6 is a schematic diagram of capacitance values under different voltages obtained by simulating the array substrate in FIG. 3 and the array substrate in FIG. 1. The capacitance value of the array substrate in FIG. 3 under the voltages is reduced about 33.2% lower than the capacitance value of the array substrate in FIG. 1 under the voltages. FIG. 7 is a schematic diagram of a driving voltage V-transmittance T curve L2 obtained by testing a display device including the array substrate of FIG. 3 under different driving voltages and a driving V-T curve L1 obtained by testing a display device including the array substrate of FIG. 1 under different driving voltages. As shown in FIG. 7, the V-T curve L2 of the display device including the array substrate of FIG. 3 substantially coincides with the V-T curve L1 of the display device including the array substrate of FIG. 1.

In the array substrate shown in FIGS. 2 and 3, width of each pixel electrode in the pattern of pixel electrodes are equal to each other, and distance between any two adjacent pixel electrodes are also equal to each other. Width of each common electrode in a pattern of common electrodes are equal to each other, and distance between any two adjacent common electrodes are also equal to each other. But, embodiments of the present disclosure are not limited thereto.

An embodiment of the present disclosure also provides a manufacturing method of an array substrate. The method includes: forming a pattern of pixel electrodes and a pattern of common electrodes over a substrate. The formed pattern of pixel electrodes and the formed pattern of common electrodes are in different layers. The formed pattern of pixel electrodes includes a plurality of strip-like pixel electrodes and the formed pattern of common electrodes includes a plurality of strip-like common electrodes.

In every two adjacent pixel electrodes, one pixel electrode has its projection on the substrate located between projections of two adjacent common electrodes, and the other pixel electrode has its projection on the substrate located within the projection of one of the two adjacent common electrodes on the substrate.

For example, when the mentioned method is used to manufacture the array substrate shown in FIG. 2 or 3, the width of each pixel electrode in the formed pattern of pixel electrodes may be equal to each other, and the distance between any two adjacent pixel electrodes may also be equal to each other. Width of each common electrode in the formed pattern of common electrodes may be equal to each other, and distance between any two adjacent common electrodes may also be equal to each other. It is helpful to reduce design and manufacturing difficulty. But, embodiments of the present disclosure are not limited thereto.

For example, when the method is used to manufacture the array substrate shown in FIG. 2 or 3, a sum of a width of a common electrode and a distance between two adjacent common electrodes may be twice of a sum of a width of a pixel electrode and a distance between two adjacent pixel electrodes. In addition, the central line of the projection of the other pixel electrode on the substrate coincides with the central line of the projection of the corresponding common electrode on the substrate. For example, the width of each formed pixel electrode may be 2.6±0.1 μm, and the distance between two adjacent pixel electrodes may be 5.4±0.1 μm.

An embodiment of the present disclosure also provides a display device including the mentioned array substrate.

The display device herein may be any product or component with display function, such as electronic paper, a mobile phone, a tablet, a TV set, a display, a notebook computer, a digital picture frame and a navigator.

In the array substrate provided in the embodiments of the present disclosure, in every two pixel electrodes, one pixel electrode has its projection located between projections of two adjacent common electrodes. In this way, half number of pixel electrodes and common electrodes do not overlapped with each other, so that it is possible to reduce the overlapping area between pixel electrodes and common electrodes, and reduce corresponding overlapping capacitance and charging difficulty.

The described above are only exemplarily embodiments of the present disclosure, and the present disclosure is not intended to be limited thereto. For a person of ordinary skill in the art, various modifications and improvements can be made without departing from the principle and spirit of the present disclosure, and all of which shall fall within the scope of the present disclosure.

The present application claims the priority and benefits of the Chinese patent application No. 201510690739.4 entitled “Array Substrate, Manufacturing Method Thereof and Display Device” filed on Oct. 22, 2015, which is incorporated in entirety herein by reference.

What is claimed is:

1. An array substrate, comprising: a substrate and a pattern of pixel electrodes and a pattern of common electrodes formed over the substrate;
wherein the pattern of pixel electrodes and the pattern of common electrodes are located in different layers; the pattern of pixel electrodes includes a plurality of strip-like pixel electrodes; the pattern of common electrodes includes a plurality of strip-like common electrodes; projection of one of every two adjacent pixel electrodes on the substrate is located between projections of two adjacent common electrodes on the substrate, and projection of the other pixel electrode of the every two adjacent pixel electrodes on the substrate is located within projection of one of the two adjacent common electrodes on the substrate.

2. The array substrate of claim 1, wherein each of the plurality of strip-like pixel electrodes in the pattern of pixel electrodes has a width equal to each other, and any two adjacent pixel electrodes have a distance equal to each other.

3. The array substrate of claim 2, wherein each of the plurality of strip-like common electrodes in the pattern of common electrodes has a width equal to each other, and any two adjacent common electrodes have a distance equal to each other.

4. The array substrate of claim 3, wherein a sum of the width of each common electrode and the distance between any two adjacent common electrodes is twice of a sum of the width of each pixel electrode and the distance between any two adjacent pixel electrodes.

5. The array substrate of claim 1, wherein the projection of the other pixel electrode on the substrate has a central line coincided with that of the projection of a corresponding common electrode on the substrate.

6. The array substrate of claim 3, wherein the width of the common electrodes equals to the distance of any two adjacent common electrodes.

7. The array substrate of claim 4, wherein the width of each pixel electrode is 2.6±0.1 μm, and the distance between any two adjacent pixel electrodes is 5.4±0.1 μm.

8. The array substrate of claim 7, wherein the width of each common electrode is 8-10 μm.

9. A method of manufacturing an array substrate, comprising:
forming a pattern of pixel electrodes and a pattern of common electrodes over a substrate, wherein the pattern of pixel electrodes and the pattern of common electrodes are formed in different layers; the pattern of pixel electrodes includes a plurality of strip-like pixel electrodes and the pattern of common electrodes includes a plurality of strip-like common electrodes; and wherein projection of one of every two adjacent pixel electrodes on the substrate is located between projections of two adjacent common electrodes on the substrate, and projection of the other pixel electrode of the every two adjacent pixel electrodes on the substrate is located within projection of one of the two adjacent common electrodes on the substrate.

10. The method of claim 9, wherein each of the plurality of strip-like pixel electrodes in the pattern of pixel electrodes has a width equal to each other, and any two adjacent pixel electrodes have a distance equal to each other.

11. The method of claim 9, wherein each of the plurality of strip-like common electrodes in the pattern of common electrodes has a width equal to each other, and any two adjacent common electrodes have a distance equal to each other.

12. The method of claim 11, wherein a sum of the width of each common electrode and the distance between any two adjacent common electrodes is twice of a sum of the width of each pixel electrode and the distance between any two adjacent pixel electrodes.

13. The method of claim 9, wherein the projection of the other pixel electrode on the substrate has a central line coincided with that of the projection of a corresponding common electrode on the substrate.

14. The method of claim 12, wherein the width of each pixel electrode is 2.6±0.1 μm, and the distance between any two adjacent pixel electrodes is 5.4±0.1 μm.

15. A display device, comprising the array substrate of claim 1.
